(19) United States
(12) Patent Application Publication
(10) Pub. No.: US 2012/0283356 A9
(43) Pub. Date: Nov. 8, 2012

(54) THERMOSETTABLE RESIN COMPOSITIONS

(76) Inventors: Hynek Benes, Prague (CZ); Jean-Francois Gerard, Bron (FR); Ludovic Valette, Lake Jackson, TX (US)

(21) Appl. No.: 13/266,173

(22) PCT Filed: Apr. 29, 2010
(86) PCT No.: PCT/US10/32970

§ 371 Date: Oct. 25, 2011

Related U.S. Application Data
(60) Provisional application No. 61/174,251, filed on Apr. 30, 2009.

(51) Int. Cl. C08G 65/333; C08L 63/02

(52) U.S. Cl. 523/400; 525/409

(57) ABSTRACT

A reactive thermosettable resin composition including (a) at least one thermosetting resin; (b) at least one curing agent, and (c) optionally, at least one catalyst; wherein the curing agent (b) comprises a reactive inorganic cluster; and wherein the clusters are storage-stable inorganic clusters with reactive functional groups, such as amino groups; a process for preparing a thermoset product from the thermosettable composition. A composition of the reactive clusters as a curing agent and a thermosetting resin may be used to prepare thermoset products with improved thermo-mechanical behavior.

### BACKGROUND OF THE INVENTION

1. Field of the Invention

The present invention is related to thermosettable compositions containing reactive inorganic clusters as a curing agent for a thermosetting resin present in such thermosettable compositions; and a process for preparing the thermosettable compositions.

The thermosettable compositions of the present invention are useful in various applications such as casting, potting, and encapsulation, such as electrical and electronics applications, and composites.

2. Description of Background and Related Art

Epoxy resins are used in combination with curing agents in various fields including for example in the field of electrical and electronic materials. For these applications materials with improved heat resistance (e.g. glass transition temperature greater than 120° C., decomposition temperature measured at 5% weight loss greater than 300° C.) and low coefficient of linear expansion (CTE) (e.g., less than 60 ppm/K at 25° C.) are required.

However, there is still a need in the industry to further improve the thermo-mechanical properties of epoxy resins; and the industry is continually searching for ways to improve the thermo-mechanical properties of epoxy resins for use in coatings, civil engineering applications, electrical laminates, and structural materials such as composites and adhesives.

It is known that the incorporation of silica structures into an epoxy matrix can lead to improved thermo-mechanical properties. The silica materials used with epoxy resins may be pre-formed silica fillers or sol-gel in situ formed silica. The prior art describes several processes used in an attempt to improve the thermo-mechanical properties of epoxy resins by incorporating a silica structure into an epoxy resin matrix. For example, a first strategy for preparing epoxy resins with silica structures involves first preparing a silicon-modified epoxy resin containing hydrolysable alkoxysilane groups, which condense during reaction with water. Then the resulting system is cured with a conventional hardener at an elevated temperature.

For example, U.S. Pat. No. 5,019,607 describes a multi-stage process including in a first step, the reaction of diglycidyl ether of bisphenol A (DGEBA) with 3-aminopropyl triethoxysilane (APS) to produce a modified epoxy resin with secondary hydroxyl groups. In the next step, these hydroxyl groups react with isocyanato (more preferred) or vinyl group or halogen atom on other alkoxysilanes. In order to obtain a final cured epoxy material which is not too brittle, replacement of only part of the hydroxyl groups (25-75% preferably) is recommended. The last step comprises the addition of water and/or tetraethoxysilane (TEOS) or tetramethoxysilane (TMOS) with mineral acid (catalyst) leading to the formation of an inorganic network followed by thermal curing. The obtained epoxy materials are cast as thin free-standing films; thus, the solvent present in the composition does not need to be removed in a preliminary stage. The resulting films of this process are transparent with improved properties at elevated temperatures. According to transmission electron microscopy (TEM) pictures, spheroidal shaped silica-rich zones are formed in the polymer matrix which significantly improved storage modulus at rubbery plateau of prepared epoxies.

U.S. Pat. No. 5,457,003 describes preparing a resist material comprising a ladder-like polysiloxane obtained by hydrolysis and condensation (under acidic conditions) of alkoxysilanes having three hydrolyzable alkoxy groups and an oxirane ring. The resulting final resist material is a top layer coated onto an organic polymer bottom layer. The composition optionally comprises an organic polymer with hydroxyl or epoxy groups.

U.S. Patent Application Publication 2004/0143062 A1 describes a multi-stage process for preparing an epoxy hybrid. First, a liquid mixture of an alkoxysilane (with epoxy- or amino-groups), water (3-0.02 moles per mole of the alkoxysilane), and a catalyst (dibutyltin dilaurate (DBTDL)) is kept at room temperature for 24 hours with stirring. Silicic compounds (RSiO_{1.5} based on T (tetra) structures with glycido or amino groups) via sol-gel process of alkoxysilane are formed. During the following step, an epoxy resin (e.g. DGEBA) is added to the silica compound and the mixture is heated to 60-160° C. for 1 hour to 10 hours in order to evaporate by-products (e.g., alcohol and water). The next step consists of adding a curing agent to the mixture and then heat treating the mixture. In comparison with epoxy resins containing no alkoxysilanes, the resulting material exhibits better mechanical properties (storage elastic modulus, thermal expansion coefficient, bending and adhesive strength) at temperatures above glass transition temperature (T_{g}).

U.S. Pat. No. 6,225,418 (related to U.S. Patent Application Publication 2004/0143062 A1 above) discloses the application of the thermosetting resin composition described in U.S. Patent Application Publication 2004/0143062 A1 for encapsulated semiconductor devices, for films, and for printed circuit substrates. No information on toughness and optical properties (refraction index) of the prepared hybrid materials is provided. Nevertheless, the relationship between the formed silica structures or the composition of the alkoxysilanes and the condition of their preparation are not mentioned. Because of the presence of multiple functional groups (amino, epoxy) in alkoxysilanes and because of the various sol-gel conditions, the formed silica structures are expected to be non-inorganic clusters.

A second strategy of prior art processes for preparing an epoxy resin with silica structures consists of preparing a partial condensate of an alkoxysilane, which in turn, is mixed with an epoxy resin; and then the mixture is cured with a hardener at an elevated temperature (e.g. greater than 80° C.).

For example, U.S. Pat. No. 4,604,443 describes preparing an ungelled partial hydrolysis product of an organosilicon-containing material by hydrolysis of organosilane compounds. The average functionality based on preferential hydrolyzable groups (alkoxy groups) is equal or greater than 2.4. The partial hydrolysis product prepared according this patent contains at least 50% of unreacted hydrolyzable groups. U.S. Pat. No. 4,604,443 only discloses the preparation of a non-aqueous coating composition based on an organic polyol and the ungelled partial hydrolysis product acting as a curing agent for said organic polyol.

U.S. Pat. No. 6,248,854 describes condensing an alkoxy-group-containing epoxysilane with longer silanol chains comprising OH reactive groups. Volatile reaction by-products (e.g., water and alcohol) are driven out by an inert gas. In this process, stable liquid products with epoxy groups, unreacted alkoxy groups and silanol groups are obtained. In the next step, the obtained product is mixed with an epoxy resin (e.g. DGEBA), a hardener and a catalyst; and then the mixed system is cured in order to build a cross-linked epoxy resin network. The thermo-mechanical properties of the prepared cast resin are not mentioned.

U.S. Pat. No. 5,492,981 describes using epoxyalkoxysilane condensates in a casting resin system for covering optoelectronic components. The casting resin system includes an epoxyalkoxysilane, a cycloaliphatic epoxy resin, and an anhydride hardener. The addition of an epoxyalkoxysilane reduces the E-modulus as well as the glass transition temperature of the resulting resin product.

U.S. Pat. No. 6,525,160 describes using alkoxysilanes or polytetramethoxysilane with a molecular weight (MO of from 260-1200 for preparing alkoxy-containing silane-modified epoxy resins. Oligomeric DGEBA containing hydroxyl groups capable of reacting with alkoxysilanes to form silicic acid ester is necessary as well as the addition of solvent to decrease the viscosity of the modified resin. The modified epoxy resin is then cured. Polyamines are mentioned as the most suitable curing agents. The final epoxies cured with dicyandiamide and triethylenetetramine, respectively show no significant shift in T_{g} when compared with the unmodified epoxy network; or the glass transition region is not clearly observed. The “inorganic-like” structure is expected to lead to stiff and brittle materials with limited toughness. The procedure disclosed in this patent is only applicable for the preparation of thin films because of the presence of a large amount of solvents in the formulation.

U.S. Pat. No. 6,441,106 describes a similar process as disclosed in U.S. Pat. No. 6,525,160 for the production of silane-modified phenolic resins. A siloxane-modified phenol resin, which is obtained by a dealcoholization condensation reaction between a phenol resin and a hydrolyzable alkoxysilane, is used as a curing agent. The hydrolyzable alkoxysilane is a polytetramethoxysilane or a combination of polytetramethoxysilane with a methyltrimethoxysilane. In order to avoid the formation of bubbles and to limit shrinkage during curing, the upper limit of silica content in the final hybrid material is 12 wt %.

U.S. Pat. No. 6,506,868 describes a multi-step process for preparing a siloxane-modified resin. In a first step of the process, a partial condensate of glycidyl ether group-containing alkoxysilanes (by dealcoholization reaction between glycidol and a partial condensate of alkoxysilane catalyzed by DBTDL) is prepared. The partial condensate of glycidyl ether group-containing alkoxysilanes is mixed with an epoxy resin and a curing agent (preferably polyamines) for the epoxy resin; and then, the mixture is cured. The partial condensate of glycidyl ether group-containing alkoxysilanes also enables the preparation of various silane-modified resins by modifying various high molecular compounds (without hydrogen bonding functional group causing a complexation of silica by sol-gel method) having acid anhydride group (polyamic acid, polymide polyether imide, polyester imide, etc.). An alkoxysilane-containing silane-modified polyimide resin, an alkoxysilane-containing silane-modified polyamideimide resin, or an alkoxysilane-containing silane-modified phenol resin can be prepared. However, due to the high viscosity of the system, solvent (dimethyl formamide, 50 wt %) has to be added to the system.

A third strategy of the prior art processes to prepare organic/inorganic hybrid materials consists of mixing monomeric alkoxysilanes into an epoxy composition. For example, U.S. Pat. No. 6,005,060 describes an epoxy composition comprising an epoxy resin; a curing agent (amines are preferred) for the epoxy; an alkoxysilane compound with epoxy or amine groups and at least two alkoxy groups connected to silicon atom in the molecule; and a catalyst for the condensation polymerization of silane compound (e.g. DBTDL). Water can be optionally added to the formulation. All components are mixed together and cured. This procedure involves a high amount (e.g. greater than 10% by weight) of volatile by-products (e.g. alcohol) and the process is applicable only for the preparation of thin films. The partial condensation of alkoxy groups in the silane compounds is not sufficient to create a large silica structure in the final hybrid material. The prepared material only contains partly condensed small-size (e.g., less than 10 microns) silica domains.

As can be gathered from the prior art, organic-inorganic hybrid materials cover a large domain of potential materials from oxides to polymers depending on the organic-inorganic ratio. A problem associated with a sol-gel process is the use of an organic solvent which must be removed from the final product. Another common issue associated with a sol-gel process is the relatively high amount (e.g. greater than 10% by weight) of volatile by-products (e.g., alcohol and water) generated during the sol-gel process. Because of these limitations, only thin materials (membranes and protective coatings) have been developed while bulk materials are not described in the prior art.

It is therefore desirable to provide a process which enables the preparation of organic-inorganic hybrid materials based on inorganic (silica-silicon) structures (clusters) and an epoxy matrix, which can be prepared without the addition of a solvent at any stage of the preparation.

### SUMMARY OF THE INVENTION

One aspect of the present invention is directed to a reactive thermosettable resin composition such as an epoxy resin composition comprising (a) at least one thermosetting resin, (b) at least one curing agent, and optionally (c) at least one catalyst; wherein the curing agent (b) comprises reactive inorganic clusters; and wherein the clusters are storage-stable inorganic clusters with reactive functional groups, such as amino groups.

The thermosettable resin composition of the present invention may be used to prepare thermoset products with improved thermo-mechanical behavior.

Another aspect of the present invention is directed to organic-inorganic hybrid materials including reactive inorganic clusters incorporated into a thermosetting resin matrix such as an epoxy resin matrix; and yet another aspect of the present invention is directed to a process for preparing said organic-inorganic hybrid materials.

An object of the present invention is to provide an organic-inorganic hybrid material useful as a reactive composition which can be used to prepare not only thin films or coatings, but also final bulk parts or products and thick parts or products with no limitation on thickness. The reactive composition may then be used in applications, such as for film or coating preparations, casting and molding (preferably in open molds), infusion, encapsulation, composites, and the like.

### BRIEF DESCRIPTION OF THE DRAWINGS

For the purpose of illustrating the present invention, the drawings show a form of the present invention which is presently preferred. However, it should be understood that the present invention is not limited to the precise arrangements and instrumentation shown in the drawings.

FIG. 1 is a graphical illustration showing Dynamic Mechanical and Thermal Analysis (DMTA) results for Examples 1-3, and 7; and Comparative Example A.

FIG. 2 is a graphical illustration showing DMTA results for Examples 3 and 4; and Comparative Example A.

FIG. 3 is a graphical illustration showing DMTA results for Examples and 6; and Comparative Examples A, B, and C.

FIG. 4 is a graphical illustration showing Young modulus (at 25° C.) results for Examples 1-3; and Comparative Example A determined from tensile measurements.

### DETAILED DESCRIPTION OF THE INVENTION

One broad aspect of the present invention comprises a reactive thermosettable resin composition, such as an epoxy resin composition, including (a) at least one thermosetting resin, (b) at least one curing agent and optionally (c) at least one catalyst; wherein the curing agent (b) comprises reactive inorganic clusters; and wherein the clusters are storage-stable inorganic clusters with reactive functional groups, such as amino groups.

In one embodiment of the present invention an organic-inorganic hybrid material incorporates inorganic clusters into a thermosetting resin matrix such as an epoxy resin matrix; wherein the inorganic clusters may be used as a curing agent for the thermosetting resin in the resin matrix.

Some of the key advantages with regard to the process related to the formulation of a thermosetting resin such as an epoxy system with inorganic clusters of the present invention include, for example, (1) use of functional amino-inorganic reactive clusters as curing agent for the thermosetting resin (alone or in combination with conventional thermosetting resin hardeners); (2) storage-stable liquid curing agent containing inorganic clusters; (3) control distribution of molecular chain dynamics through tailoring of organic-inorganic network; (4) improvement of thermo-mechanical behavior of organic-inorganic network during thermal aging; (5) enhanced balance of thermo-mechanical properties (transition temperature, modulus, and toughness) of the organic-inorganic network in the glassy state as well as in the rubbery region; and (6) possibility to prepare organic-inorganic network in the form of thick products/bulk parts (in addition to thin films).

In general, the present invention comprises a thermosettable resin composition (also referred to herein interchangeably as “system” or “formulation”) comprises (a) at least one thermosetting resin and (b) at least one curing agent; wherein the curing agent comprises at least one reactive inorganic cluster of the present invention as described above. For example, in one embodiment of the reactive thermosettable composition of the present invention comprises (a) at least one epoxy resin and (b) at least one inorganic cluster as a curing agent.

As one illustration of the present invention, a silica structure may be incorporated into an epoxy resin matrix to prepare a silicon-modified epoxy resin containing hydrolysable alkoxysilane groups, wherein the hydrolysable alkoxysilane groups condense during the reaction with water. Then, the above silicon-modified epoxy resin system may be cured with a conventional hardener at an elevated temperature to form a cured epoxy resin product.

The formulation of the epoxy resin system with inorganic clusters has the following advantages and/or benefits:

(1) The use of functional amino-inorganic reactive clusters as curing agent for epoxy (alone or in combination with conventional hardeners for epoxy). The functional amino groups of the clusters enable good incorporation into the epoxy matrix by curing reaction of amino and epoxy groups. The cured organic-inorganic networks provide improved thermo-mechanical behavior than neat epoxies.

(2) The use of storage-stable liquid curing agent containing inorganic clusters. The prepared clusters can be stored alone or in the combination with conventional liquid curing agents.

(3) The ability to control distribution of molecular chain dynamics through tailoring of organic-inorganic network. Different amounts (and types) of the clusters in the epoxy formulation enable to prepare the organic-inorganic networks with different thermo-mechanical behavior.

(4) The use of the clusters provides an improvement of thermo-mechanical behavior of organic-inorganic network during thermal aging. The organic-inorganic networks have better resistance against thermal aging than neat epoxies.

(5) The use of the clusters provides an enhanced balance of thermo-mechanical properties (transition temperature, modulus, and toughness) of the organic-inorganic network in the glassy state as well as in the rubbery region. During thermal aging, the crosslinking density of the inorganic network increases leading to an improvement of thermo-mechanical behavior.

(6) The use of the clusters provides the ability to prepare organic-inorganic network in the form of thick products/bulk parts (in addition to thin films) The organic-inorganic network products (thin films as well as thick/bulk products) prepared from the clusters provide improved thermo-mechanical behavior than the same products prepared from a neat epoxy.)

Component (a) of the present invention may be selected from known thermosetting resins in the art including at least one resin selected from epoxy resins; isocyanate resins; (meth)acrylic resins; phenolic resins; vinylic resins; styrenic resins; polyester resins; melamine resins; vinylester resins; silicone resins; and mixtures thereof.

In one preferred embodiment, the curable epoxy resin composition of the present invention may include at least one epoxy resin, component (a). Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric. An extensive enumeration of epoxy resins useful in the present invention is found in Lee, H. and Neville, K., “Handbook of Epoxy Resins,” McGraw-Hill Book Company, New York, 1967, Chapter 2, pages 257-307; incorporated herein by reference.

The epoxy resins, used in embodiments disclosed herein for component (a) of the present invention, may vary and include, for example, conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

In general, the choice of the epoxy resin used in the present invention depends on the application. Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments of the epoxy resin include, for example, bisphenol A diglycidyl ether, bisphenol F diglycidyl ether, resorcinol diglycidyl ether, triglycidyl ethers of para-aminophenols and mixtures of two or more of the epoxy resins. Other suitable epoxy resins known to the skilled worker include reaction products of epichlorohydrin with o-cresol; novolac epoxy resins, glycidylamine-based epoxy resins, alicyclic epoxy resins, linear aliphatic epoxy resins, tetrabromobisphenol A epoxy resins, and combinations thereof. Diglycidyl ether of bisphenol A (DGEBA) and derivatives thereof are particularly preferred.

The epoxy resins, component (a), useful in the present invention for the preparation of the curable compositions, may be selected from commercially available products. For example, D.E.R.™ 331, D.E.R. 332, D.E.R. 334, D.E.R. 580, D.E.N. 431, D.E.N. 438, D.E.R. 736, or D.E.R. 732 available from The Dow Chemical Company may be used. As an illustration of the present invention, the epoxy resin component (a) may be a liquid epoxy resin, D.E.R.® 383 (DGEBPA) having an epoxide equivalent weight of 175-185, a viscosity of 9.5 Pa-s and a density of 1.16 gms/cc. Other commercial epoxy resins that can be used for the epoxy resin component can be D.E.R. 330, D.E.R. 354, or D.E.R. 332.

Other suitable epoxy resins useful as component (a) are disclosed in, for example, U.S. Pat. Nos. 3,018,262. 7,163,973, 6,887,574, 6,632,893, 6,242,083, 7,037,958, 6,572,971, 6,153,719, and 5,405,688, PCT Publication WO 2006/052727; U.S. Patent Application Publication Nos. 20060293172, 20050171237, 2007/0221890 A1; each of which is hereby incorporated herein by reference.

The thermosetting resin, component (a), may be present in the thermosetting composition at a concentration ranging generally from about 10 weight percent (wt %) to about 95 wt %, preferably from about 20 wt % to about 90 wt %, and more preferably from about 30 wt % to about 80 wt %.

The inorganic reactive clusters and the preparation of the reactive clusters useful in the thermosettable composition of the present invention are as described in U.S. Provisional Patent Application Ser. No. 61/174,255 filed Apr. 30, 2009 by Benes et al. (Attorney Docket No. 67810); incorporated herein by reference.

The prepared inorganic reactive clusters of the present invention have sufficiently low viscosity and are advantageously liquid at room temperature. Thus, the clusters may be easily admixed into an epoxy resin composition and incorporated into a liquid epoxy formulation. The prepared inorganic reactive clusters of the process of the present invention may contain fully converted T₃ and D₂ units in the amount of at least about 50% and about 15% (expressed as a percentage of D or T species), respectively; and preferably in the amount of at least about 60% and about 20%, respectively. The nomenclature referring to T₃ and D₂ are well known in the art and are used to describe the type of siloxane units in siloxane-based compounds. D herein refers to diethoxysilane, T refers to triethoxysilane; whereas the superscript number is the number of hydrolyzed ethoxy groups, and the subscript number is the number of condensed ethoxy groups. The prepared inorganic reactive clusters that fulfill the above conditions form a storage-stable system suitable for further admixing into an epoxy formulation.

Also, the structure/branching degree of the clusters may be controlled through the ratio of the condensed and uncondensed Si-species (D and T) based on ²⁹Si NMR analysis.

The reactive inorganic clusters prepared by the sol-gel process of the present invention offer several advantages because of the structure of the reactive inorganic clusters. For example, the clusters have long storage-stability in a sealed container. By “storage-stable” herein it is meant that the inorganic clusters are stable for certain extended period of time, i.e., the clusters do not form macro-gelation for more than about 1 day, preferably for more than about 1 week, more preferably for more than about 2 weeks, even more preferably for more than about 1 month, and most preferably for more than about 3 months when stored at 25° C. in a sealed container.

The functionality of the clusters may be controlled through adjusting the ratio of different amino precursors; or through adjusting the ratio of different amino precursors and precursors with other functional groups or precursors without functional groups.

Furthermore, the present invention allows the adjusting of the optimal concentration of reactive amino groups for the clusters; that is, the total amount of amino groups in the clusters can be adjusted by a selection of suitable precursors with different amounts of amino groups.

The resulting hydrolysis-condensation product, i.e. the reactive inorganic cluster product, obtained by the sol-gel process described above, is a colorless low viscosity liquid containing reactive amino groups.

In one embodiment of the present invention, the reactive inorganic clusters can be used alone as the curing agent for an epoxy resin. The formed reactive inorganic clusters may be applied as a curing agent for epoxy resins due to the presence of functional groups, for example, amino groups.

In another embodiment, the formed reactive inorganic clusters may optionally be used in combination with conventional epoxy resin curing agents (co-curing agents), as component (b), such as for example conventional amino-containing curing agents.

The curing agent, component (b), useful for the epoxy resin composition of the present invention, comprises the reactive inorganic clusters of the present invention. The reactive inorganic clusters of the present invention may be used alone, as component (b), i.e., the curing agent may comprise the reactive inorganic clusters without addition of any conventional epoxy hardeners; or in the alternative, the reactive inorganic clusters of the present invention may be used with additional conventional co-curing agents known in the art for curing epoxy resins. In this embodiment the curing agent, component (b), comprises the prepared reactive inorganic clusters and at least one conventional epoxy co-curing agent. The reactive inorganic clusters can be conveniently and readily blended and used with conventional epoxy curing agents. The reactive inorganic clusters alone, or in combination with conventional epoxy co-curing agents, form storage-stable liquid curing agents for thermosetting resins such as epoxy resins at ambient temperature. The prepared final organic-inorganic network exhibits more inorganic-like character. Generally the higher the concentration of reactive inorganic clusters in the curing agent (b), the higher the rubbery modulus of the cross-linked network.

The co-curing agents, (also referred to as a co-hardener or co-cross-linking agent) useful in the thermosettable composition, may be selected, for example, from those curing agents well known in the art including, but are not limited to, anhydrides, carboxylic acids, amine compounds, phenolic compounds, polyols, or mixtures thereof.

As an illustration of one embodiment wherein the thermosetting resin comprises an epoxy resin, at least one co-curing agent may be selected from amines, phenolic resins, carboxylic acids, carboxylic anhydrides, or mixtures thereof.

As an illustration of one embodiment wherein the thermosetting resin comprises an isocyanate, the at least one co-curing agent may be selected from at least one polyol.

Examples of the optional co-curing agent useful in the present invention may include any of the curing materials known to be useful for curing epoxy resin based compositions. Such materials include, for example, polyamine, polyamide, polyaminoamide, dicyandiamide, polyphenol, polymeric thiol, polycarboxylic acid and anhydride, polyol, tertiary amine, quaternary ammonium halide, and any combination thereof or the like. Other specific examples of the co-curing agent include phenol novolacs, bisphenol-A novolacs, phenol novolac of dicyclopentadiene, cresol novolac, diphenylsulfone, styrene-maleic acid anhydride (SMA) copolymers; and any combination thereof. The co-curing agents sensitive to the presence of water/ethanol in the composition (e.g. anhydrides) are usually not recommended.

Dicyandiamide (“dicy”) may be one preferred embodiment of the co-curing agent useful in the present invention. Dicy has the advantage of providing delayed curing since dicy requires relatively high temperatures for activating its curing properties; and thus, dicy can be added to an epoxy resin and stored at room temperature (about 25° C.).

Among the conventional epoxy co-curing agents, amines and amino or amido containing resins are preferred due to their catalytic effect on the alkoxy groups of the reactive inorganic clusters. Solid epoxy co-curing agents at ambient temperature can be advantageously dissolved in the reactive inorganic clusters leading to formation of a liquid (b) curing agent.

The amount of the curing agent, component (b), for the thermosetting resin composition, such as the epoxy resin composition, is usually such that the equivalent ratio of a functional group having an active hydrogen in the curing agent (the total amount of active hydrogens from the reactive inorganic clusters and from the other conventional co-curing agent, if used) to the epoxy groups in the epoxy resin (a) in the total reactive epoxy resin composition is from about 0.2:1 to about 5:1, preferably from about 0.5:1 to about 2:1, and more preferably from about 0.9:1 to about 1.1:1 Below the ratio of 0.2:1 and above the ratio of 5:1, the glass transition temperature of the network may become lower, or the reactive functions may remain in the network and may increase the water absorption in humid environment; and generally, no networks may be obtained.

An optional component useful in the thermosettable composition of the present invention includes at least one catalyst. The catalyst used in the present invention may be adapted for polymerization, including homopolymerization, of the at least one thermosetting resin. Alternatively, catalyst used in the present invention may be adapted for a reaction between the at least one thermosetting resin and the at least one reactive clusters and co-curing agent, if used.

The selection of the catalyst useful in the present invention is not limited and commonly used catalysts for thermosetting systems such as epoxy systems can be used. Also, the addition of a catalyst may depend on the system prepared. The optional catalyst, component (c), useful in the present invention may include catalysts well known in the art, such as for example, catalyst compounds containing amine, phosphine, heterocyclic nitrogen, ammonium, phosphonium, arsonium, sulfonium moieties, and any combination thereof. Whenever the catalyst is used some non-limiting examples of the catalyst, component (c), of the present invention may include, for example, ethyltriphenylphosphonium; benzyltrimethylammonium chloride; heterocyclic nitrogen-containing catalysts described in U.S. Pat. No. 4,925,901, incorporated herein by reference; imidazoles; triethylamine; tripropylamine, tributylamine, 2-methylimidazole, benzyldimethylamine, and any combination thereof.

The concentration of the catalyst present in the thermosetting composition ranges generally from about 0.01 wt % to about 5 wt %, preferably from about 0.05 wt % to about 2 wt %, and more preferably from about 0.1 wt % to about 1 wt % based on the total organic compounds in the composition. Above the about 5 wt % range, the reaction may be too fast (the reaction is a strong exotherm which can degrade the material) leading possibly to poor processability; and thus, the formulation may not be processed under conventional processing conditions. Below the about 0.01 wt % range, the reaction may be too slow prolonging the curing time; and thus, the formulation may not be processed under conventional processing conditions.

The thermosettable composition of the present invention may optionally contain one or more other additives which are useful for their intended uses. For example, the optional additives useful in the present invention composition may include, but not limited to, stabilizers, surfactants, flow modifiers, pigments or dyes, matting agents, degassing agents, flame retardants (e.g., inorganic flame retardants, halogenated flame retardants, and non-halogenated flame retardants such as phosphorus-containing materials), toughening agents, curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof. The above list is intended to be exemplary and not limiting. The preferred additives for the, formulation of the present invention may be optimized by the skilled artisan.

The concentration of the additional additives is generally between about 0 wt % to about 50 wt %, preferably between about 0.01 wt % to about 20 wt %, more preferably between about 0.05 wt % to about 15 wt %, and most preferably between about 0.1 wt % to about 10 wt % based on the weight of the total composition. Below about 0.01 wt %, the additives generally do not provide any further significant advantage to the resultant thermoset product; and above about 20 wt %, the properties improvement brought by these additives remains relatively constant.

The components of the formulation or composition of the present invention may be admixed in any order to provide the thermosettable composition of the present invention. The formulation of the present invention composition can be cured under conventional processing conditions to form a thermoset. The resulting thermoset displays excellent thermo-mechanical properties, such as good toughness and mechanical strength, while maintaining high thermal stability.

All the components of the thermosettable epoxy resin composition are typically mixed and dispersed at a temperature enabling a low viscosity for the effective incorporation of the inorganic reactive clusters into the epoxy matrix. The temperature during the mixing of all components may be at ambient temperature, or generally from about 20° C. to about 90° C., and more preferably from 50° C. to 80° C. The volatile by-products can be removed by vacuum degassing of the curing agent or of the formulated mixture of curing agent. Above the temperature of about 90° C., the crosslinking reaction may prematurely start during the mixing of components, and below the temperature of 20° C., the viscosity of the composition may be too high to thoroughly and homogeneously mix the components together.

When degassing is performed at elevated temperature (i.e. higher than about 50° C.), it is preferred to degas the curing agent before the addition of the epoxy resin to avoid reaction between epoxy and amine during the process. Degassing is recommended when bulk and thick products are prepared.

While the order of mixing is not critical under most processing conditions when a liquid amino hardener is used, in some instances, for example when a solid amino co-curing agent is used such as aromatic amines including for example diaminodiphenyl sulfone (DDS), diaminodiphenyl methane (DDM), m-phenylenediamine (mPDA), diaminodiphenyl ether, alkylated aromatic amines, dicyandiamide (DICY), the epoxy resin and the solid co-curing agent must first be mixed together at a high temperature (e.g., from about 120° C. to about 130° C.) to mix the co-curing agent homogeneously with the other components; and then the clusters may be added at a lower temperature (e.g., from about 20° C. to about 90° C.) because the functional groups on the clusters, such as the amino groups, are very reactive.

The process to produce the thermoset products of the present invention may be performed by gravity casting, vacuum casting, automatic pressure gelation (APG), vacuum pressure gelation (VPG), infusion, filament winding, lay up injection, transfer molding, prepreging, dipping, coating, spraying, brushing, and the like.

The curing of the thermosettable composition may be carried out for a predetermined period of time sufficient to cure the composition. For example, the curing time may be chosen between about 1 minute to about 96 hours, preferably between about 5 minutes to about 48 hours, and more preferably between about 10 minutes to about 24 hours. Below a period of time of about 1 minute, the time may be too short to ensure sufficient reaction under conventional processing conditions; and above about 96 hours, the time may be too long to be practical or economical.

In the present invention, incorporation of a reactive inorganic cluster (with amino groups), containing large highly condensed and branched inorganic (silicon-rich in the case of alkoxysilane precursors) structures, into the epoxy matrix leads to a creation of inorganic structures with branched and chain-like architecture which do not form agglomerates and are well distributed in the epoxy matrix enabling to produce transparent homogenous organic-inorganic network material.

The final organic-inorganic hybrid network morphology is like a mixed structure of the epoxy-rich matrix with well dispersed condensed inorganic clusters adding cross-links (interpenetrated networks “IPN”-like morphology) and thus denser network structure is created. A broad size-distribution of reactive inorganic clusters leads also to a broadening of the main transition region (alpha relaxation, Tα) of the epoxy hybrids in comparison with neat epoxy matrix. Varying the amount of inorganic reactive clusters into the epoxy formulation enables to control the final distribution of molecular chain dynamics through tailoring of organic-inorganic network. Maximum amount of added inorganic reactive clusters is not limited. Nevertheless, the maximum concentration in the final organic-inorganic network is usually limited by the amount of amino groups in order to respect the stoichiometric ratio between epoxy/amino groups.

Thermo-mechanical properties of the final organic-inorganic networks show a significant improvement of storage modulus in the rubbery state as well as in the glassy state. A shift of the main transition region to higher temperatures is also observed. Moreover, the thermo-mechanical properties of organic-inorganic networks are further improved during longer post-curing or during thermal aging of materials. The positive effect of thermal treatment is caused by the densification of the inorganic phase due to a final condensation of remaining hydroxyl groups. This effect does not have great influence on the final rubbery modulus, because the organic network and the connections between organic and inorganic phases are already created. Nevertheless a significant shift of the main transition region to higher temperature region is observed.

A cured product of the present invention may be prepared by curing the reactive thermosettable resin composition comprising (a) at least one thermosetting resin, (b) at least one curing agent and optionally (c) at least one catalyst; wherein the curing agent (b) comprises a reactive inorganic cluster; and wherein the clusters are storage-stable inorganic clusters with reactive functional groups. The cured product preparing by curing the composition of the present invention advantageously demonstrates improved thermo-mechanical properties. For example, the rubbery modulus E′ r of the cured product determined by DMTA may be from about 20 MPa to about 2000 MPa; preferably from about 22 MPa to about 1000 MPa; more preferably from about 25 MPa to about 600 MPa; and most preferably from about 30 MPa to about 200 MPa. The mechanical transition temperature Tα of the cured product determined by DMTA may be from about 60° C. to about 240° C.; preferably between about 70° C. and about 220° C.; more preferably between about 80° C. and about 200° C.; and most preferably between about

90° C. and about 180° C. The Young's modulus E of the cured product determined by tensile test may be from about 2 GPa to about 10 GPa; preferably from about 2.1 GPa to about 8 GPa; more preferably from about 2.2 GPa to about 6 GPa; and most preferably from about 2.3 GPa to about 4 GPa. The KIc of the cured product may be from about 0.5 MPa·m^{0.5} to about 3 MPa·m^{0.5}; preferably from about 0.6 MPa·m^{0.5} to about 2.8 MPa·m^{0.5}; more preferably from about 0.7 MPa·m^{0.5} to about 2.6 MPa·m^{0.5}; and most preferably from about 0.8 MPa·m^{0.5} to about 2.4 MPa·m^{0.5}. The decomposition temperature Td of the cured product may be from about 300° C. to about 450° C.; preferably from about 310° C. to about 420° C.; more preferably from about 320° C. to about 400° C.; and most preferably from about 325° C. to about 380° C.

The cured product, i.e., the organic-inorganic hybrid material product advantageously has an improved balance of thermo-mechanical properties (transition temperature, modulus, and toughness) in the glassy state or in the rubbery region. The organic-inorganic hybrid material product has improved the thermo-mechanical behavior (such as higher transition temperature, modulus, or toughness) during thermal aging. In addition, the cured product of the present invention advantageously may be transparent or opalescent as assessed by visual inspection. Furthermore, cured product may also have a transmittance at 520 nm of from about 60% to about 95%; preferably from about 62% to about 90%; more preferably from about 64% to about 85%; and most preferably from about 65% to about 80%. Other properties may be measured as well known by the skilled artisan.

As an illustration of the present invention, in general, epoxy-type impregnating compounds, may be useful for casting, potting, encapsulation, molding, and tooling. The present invention is particularly suitable for all types of electrical casting, potting, and encapsulation applications; for molding and plastic tooling; and for the fabrication of epoxy based composites parts, particularly for producing large epoxy-based parts produced by casting, potting and encapsulation. The resulting composite material may be useful in some applications, such as electrical casting applications or electronic encapsulations, castings, moldings, potting, encapsulations, injection, resin transfer moldings, composites, coatings and the like.

### EXAMPLES

The following examples and comparative examples further illustrate the present invention in detail but are not to be construed to limit the scope thereof. The formulation of epoxy systems with reactive inorganic clusters and the properties of cured product organic-inorganic networks are illustrated in the following Examples.

The following Synthesis Examples 1 to 4 and Comparative Synthesis Example A describe the preparation of inorganic reactive clusters.

### Synthesis Example 1

Into a batch reactor equipped with a mechanical stirrer, thermometer, nitrogen gas introduction tube, a mixture of 150 grams (g) of 3-aminopropyltriethoxysilane (APS, produced by ABCR) and 64.8 g of 3-aminopropylmethyldiethoxysilane (APMS, produced by ABCR) were introduced. The mixture of APMS and APS was heated to 90° C. and purged with nitrogen saturated by water vapor in order to promote the hydrolysis and condensation reactions. The water saturation of the gas was performed at 25° C. in bubbler and outgoing nitrogen contained 16 mg H₂O in 1 dm³. Ethanol formed during the reactions was evaporated and then condensed in a separate vessel. The course of reactions was controlled by measuring the viscosity of the mixture. The reaction was stopped when the viscosity reached 72 mPa·s at 25° C. From the Si NMR results, the conversion of alkoxysilane groups was 63%. The obtained product (reactive inorganic clusters) was a clear transparent liquid which was used for further preparation of final organic-inorganic hybrid networks.

### Synthesis Example 2

In the same reactor as described in Synthesis Example 1, a mixture of 150 g of APS and 64.8 g of APMS were introduced in the reactor. The reaction was carried out following the same procedure as described in Synthesis Example 1. The reaction was stopped when the viscosity reached 60 mPa·s at 25° C. From the Si NMR results, the conversion of alkoxysilane groups was 57%. The obtained product (reactive inorganic clusters) was a clear transparent liquid which was used for further preparation of final organic-inorganic hybrid networks.

### Synthesis Example 3

In the same reactor as described in Synthesis Example 1, a mixture of 150 g of APS and 64.8 g of APMS were introduced in the reactor. The reaction was carried out following the same procedure as described in Synthesis Example 1. The reaction was stopped when the viscosity reached 66 mPa·s at 25° C. The mixture was then heated for 30 min at 90° C. under vacuum in order to remove the residue of ethanol. The obtained product (reactive inorganic clusters) had a viscosity of 108 mPa·s at 25° C., the conversion of alkoxysilane groups was 64% (from Si NMR results). The product was a clear transparent liquid which was used for further preparation of final organic-inorganic hybrid networks.

### Synthesis Example 4

In the same reactor as described in Example 1, a mixture of 150 g of APS and 64.8 g of APMS were introduced in the reactor. The reaction was carried out following the same procedure as described in Example 1. The reaction was stopped when the viscosity reached 559 mPa·s at 25° C. From the Si NMR results, the conversion of alkoxysilane groups was 85%. The obtained product (reactive inorganic clusters) was a clear transparent liquid which was used for further preparation of final organic-inorganic hybrid networks.

### Synthesis Example A

In the same reactor as described in Synthesis Example 1, a mixture of 150 g of APS and 64.8 g of APMS were introduced in the reactor. The reaction was carried out following the same procedure as described in Synthesis Example 1. The reaction was stopped when the viscosity reached 4.5 mPa·s at 25° C. From the Si NMR results, the conversion of alkoxysilane groups was 23%. The obtained product was a clear transparent liquid which was used for further preparation of final organic-inorganic hybrid networks.

The following Examples 1 to 7 and Comparative Examples A to C describe the formulation of an epoxy system and the inorganic clusters prepared above.

### Example 1

142.6 g of bisphenol A epoxy resin (D.E.R.™ 332, manufactured by and commercially available from The Dow Chemical Company), 38.1 g of polyoxypropylene diamine (JEFFAMINE™ D-230, manufactured by Huntsman and commercially available) and 9 g of the reactive amino-inorganic clusters prepared in Synthesis Example 1 were mixed together and homogenized by disc-shaped agitator for about 15 minutes (2 400 rpm) at 60° C. The system was degassed under vacuum for 5 minutes at 40° C. Then, the reactive system was poured into pre-heated aluminum open molds with different thickness: from about 1 mm (samples for dynamical mechanical analysis) up to about 6 mm (samples for fracture toughness measurement) and cured 1.5 hour (h) at 65° C., followed by 2 h at 80° C. and post cured 12 h at 180° C. Prepared fully cured organic-inorganic networks were further characterized. The composition of Example 1 is described in Table I.

### Examples 2 and 3

The same procedure as described in Example 1 was applied for the preparation of organic-inorganic materials in Examples 2 and 3. The composition of Examples 2 and 3 are described in Table I.

### Examples 4

The same procedure as described in Example 1 was applied for the preparation of organic-inorganic materials in Example 4 except that the reactive amino-inorganic clusters prepared in Synthesis Example 3 were used. The composition of Example 4 is described in Table I.

### Example 5

The same procedure as described in Example 1 was applied for the preparation of organic-inorganic materials in Example 5 except that the reactive amino-inorganic clusters prepared in Synthesis Example 4 were used. The composition of Example 5 is described in Table I.

### Example 6

39.6 g of bisphenol A epoxy resin (D.E.R.™ 332) and a curing agent consisting in the pre-blended 2.7 g of polyoxypropylene diamine (trade name: JEFFAMINE™ D-230) and 10.0 g of the reactive amino-inorganic clusters prepared in Synthesis Example 3 were mixed together and homogenized by disc-shaped agitator for about 15 min (2 400 rpm) at 60° C. Then, the reactive system was poured into pre-heated aluminum open molds with different thickness: from ca. 1 mm (samples for dynamical mechanical analysis) up to ca. 6 mm (samples for fracture toughness measurement) and cured 4 h at 80° C. and post cured 12 h at 180° C. Prepared fully cured organic-inorganic networks were further characterized. The composition of Example 6 is described in Table I.

### Example 7

31.6 g of bisphenol A epoxy resin (D.E.R.™ 332) and 10.0 g of the reactive amino-inorganic clusters prepared in Synthesis Example 1 were mixed together and homogenized by disc-shaped agitator for about 15 minutes (2 400 rpm) at 60° C. The system was degassed under vacuum for 5 minutes at 40° C. Then, the reactive system was poured into pre-heated aluminum open molds with different thickness: from about 1 mm (samples for dynamical mechanical analysis) up to about 6 mm (samples for fracture toughness measurement) and cured 1.5 h at 65° C., followed by 4 h at 80° C. and post cured 12 h at 180° C. Prepared fully cured organic-inorganic networks were further characterized. The composition of Example 7 is described in Table I.

### Comparative Example A

142.6 g of bisphenol A epoxy resin (D.E.R.™ 332) and 47.7 g of polyoxypropylene diamine (JEFFAMINE™ D-230) were mixed together and homogenized by disc-shaped agitator for about 15 minutes (2 400 rpm) at 60° C. The system was degassed under vacuum for 5 minutes at 40° C. Then, the reactive system was poured into pre-heated aluminum open molds with different thickness: from about 1 mm (samples for dynamical mechanical analysis) up to 6 mm (samples for fracture toughness measurement) and cured 1.5 h at 65° C., followed by 2 h at 80° C. and post cured 12 h at 180° C. Prepared fully cured organic-inorganic networks were further characterized. The composition of Comparative Example A is described in Table I.

### Comparative Example B

39.6 g of bisphenol A epoxy resin (D.E.R.™ 332), 2.7 g of polyoxypropylene diamine (JEFFAMINE™ D-230) and 10.0 g of the product prepared in Synthesis Example A were mixed together and homogenized by disc-shaped agitator for about 15 minutes (2 400 rpm) at 60° C. The system was degassed under vacuum for 5 minutes at 40° C. Then, the reactive system was poured into pre-heated aluminum open molds with a thickness of about 1 mm and cured 4 h at 80° C. and post cured 12 h at 180° C. Prepared fully cured organic-inorganic networks were further characterized. The composition of Comparative Example B is described in Table I.

### Comparative Example C

54.4 g of bisphenol A epoxy resin (D.E.R.™ 332), 6.1 g of polyoxypropylene diamine (JEFFAMINE™ D-230), 15.0 g of APS (produced by ABCR) and 6.5 g of APMS (produced by ABCR) were mixed together and homogenized by disc-shaped agitator for about 15 minutes (2 400 rpm) at 60° C. The system was degassed under vacuum for 15 minutes at 40° C. Then, the reactive system was poured into pre-heated aluminum open molds with a thickness of about 1 mm and cured 1.5 h at 65° C., followed by 2 h at 80° C. and post cured 12 h at 180° C. Prepared fully cured organic-inorganic networks were further characterized. The composition of Comparative Example C is described in Table I.

The compositions of all reactive systems mentioned in Examples 1-7 and Comparative examples A-C are described in Table I.

TABLE I
Composition of Epoxy Networks

| | Examples | | | | | | | Comparative Examples | | |
|---|---|---|---|---|---|---|---|---|---|---|
| | 1 | 2 | 3 | 4 | 5 | 6 | 7 | A | B | C |
| Epoxy resin | 142.6 | 138.5 | 158.4 | 39.0 | 59.4 | 39.6 | 31.6 | 142.6 | 39.6 | 54.4 |
| D.E.R. ™ 332 [g] | | | | | | | | | | |
| Amine hardener | 38.1 | 27.2 | 10.6 | 2.6 | 4.0 | 2.7 | — | 47.7 | 2.7 | 6.1 |
| JEFFAMINE ™ D230 [g] | | | | | | | | | | |
| Reactive inorganic clusters prepared in: | | | | | | | | | | |
| Synthesis Example 1 [g] | 9.0 | 18.0 | 40.0 | — | — | — | 10.0 | — | — | — |
| Synthesis Example 2 [g] | — | — | — | 10.0 | — | — | — | — | — | — |
| Synthesis Example 3 [g] | — | — | — | — | — | 10.0 | — | — | — | — |
| Synthesis Example 4 [g] | — | — | — | — | 15.0 | — | — | — | — | — |
| Product prepared in | — | — | — | — | — | — | — | — | 10.0 | — |
| Comparative Example A [g] | | | | | | | | | | |
| APMS [g] | — | — | — | — | — | — | — | — | — | 6.5 |
| APS [g] | — | — | — | — | — | — | — | — | — | 15.0 |
| Theor. SiO₂ eq. | 2.5 | 5.2 | 10.2 | 10.2 | 10.2 | 10.2 | 12.8 | 0 | 10.2 | 7.5 |
| content [wt. %] | | | | | | | | | | |

The following standard analytical equipments and methods are used in the Examples:

### Dynamic Mechanical and Thermal Analysis (DMTA)

The above cured samples were tested for their dynamical thermo-mechanical properties (storage modulus E′ and mechanical transition temperature Ta) with a Rheometrics Solid Analyser (RSA II) operating in tensile mode with the following experimental conditions: sample dimension: about 40×5×1 mm³; frequency: 1 Hz; and heating rate: 2 K·min⁻¹ Tα was determined by the maximum of the tan δ peak. The rubbery modulus E′ r was determined at the rubbery plateau. The typical precision of the measurements is Tα±2° C. and E′ r±5%.

### Tensile Measurement

Tensile measurements leading to the determination of Young modulus E at 25° C. were performed with an Instron machine (sample dimension: 6×12×80 mm³, straight strain gages, speed: 0.2 mm·min⁻¹). The typical precision of the measurements is E±5%.

### Fracture Toughness Test

Fracture toughness K_{Ic} tests were carried out on pre-notched samples (by thin blade) with a MTS-2/M machine (sample dimension: 6×12×80 mm³, 3-point bending test, speed: 10 mm·min⁻¹). The typical precision of the measurements is K_{Ic}±5%.

### Thermogravimetric Analysis (TGA)

TGA spectra were recorded on a TGA 2950 (Thermal Analysis Instrument) on small film samples (about 10 mg). The weight loss was measured under oxidizing atmosphere (air) using a heating rate of 10 K·min⁻¹ up to temperature of 800° C. using platinum pan. The thermal decomposition temperature Td was recorded at 10% weight loss.

### Transparency

Transparency was assessed by visual inspection.

### Thermal Aging

Thermal aging tests (thermo-oxidation) were performed at 150° C. in air in a ventilated oven for 250 hours. The tests were performed on thin films (1 mm thickness). The evaluation consisted in the visual inspection of the films after aging (color), the measurement of transmittance at a wave length of 520 nm, and the evaluation of the thermo-mechanical properties by DMTA. The typical precision of the measurements is transmittance ±10%.

### Viscosity Measurements

The viscosity measurements were carried out using the following method: Viscosity measurements of the reaction products at different reaction times were realized using a rheometer AR 1000 (Thermal Analysis) at 25° C. A cone/plate geometry (60 mm diameter, 2° angle, 66 μm gap) and a shear rate sweep from 1 to 100 s⁻¹ were used.

### Results

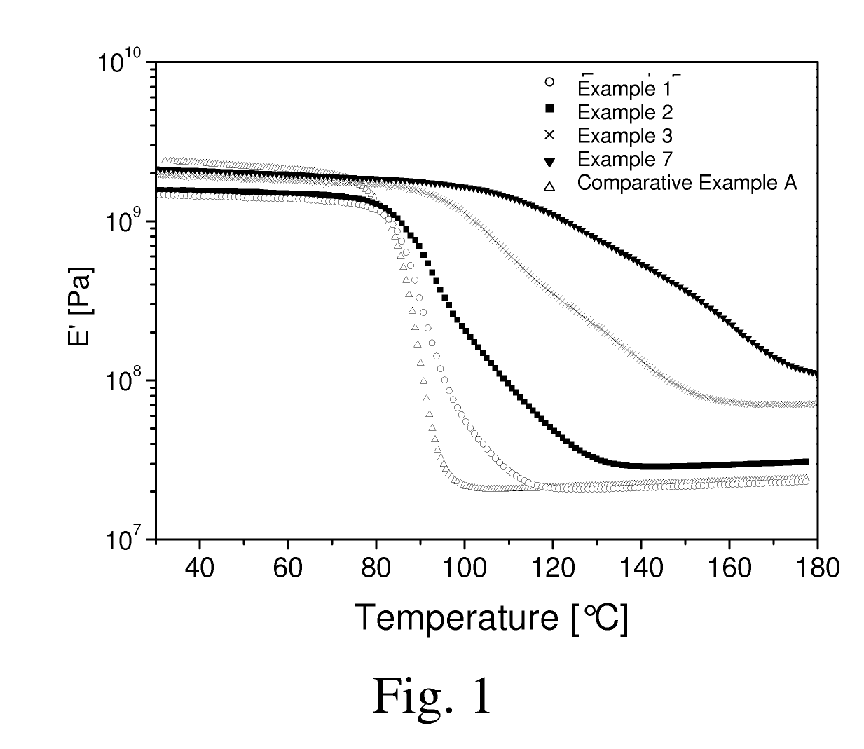

The results of the above testing procedures are illustrated in FIGS. 1-4 and Table II. The results indicate improved thermo-mechanical properties for the Examples of the present invention as shown in FIGS. 1-4 when compared with the corresponding Comparative Examples. The key properties are given in Table II.

FIG. 1 shows an improvement of thermo-mechanical properties of organic-inorganic networks with different amount of SiO₂ (Examples 1, 2, 3 and 7) in comparison with epoxy matrix without inorganic clusters (Comparative Example A). The compositions of the present invention show a higher mechanical transition temperature Tα and/or a higher rubbery modulus than the comparative compositions.

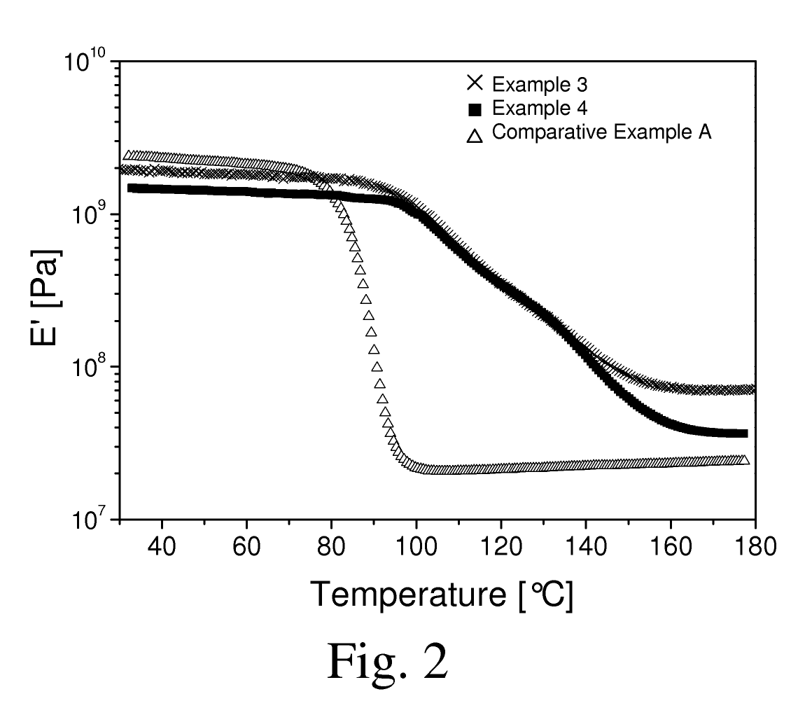

FIG. 2 shows an improvement of thermo-mechanical properties of organic-inorganic networks with different structure of inorganic clusters (Examples 3 and 4) in comparison with epoxy matrix without inorganic clusters (Comparative Example A).

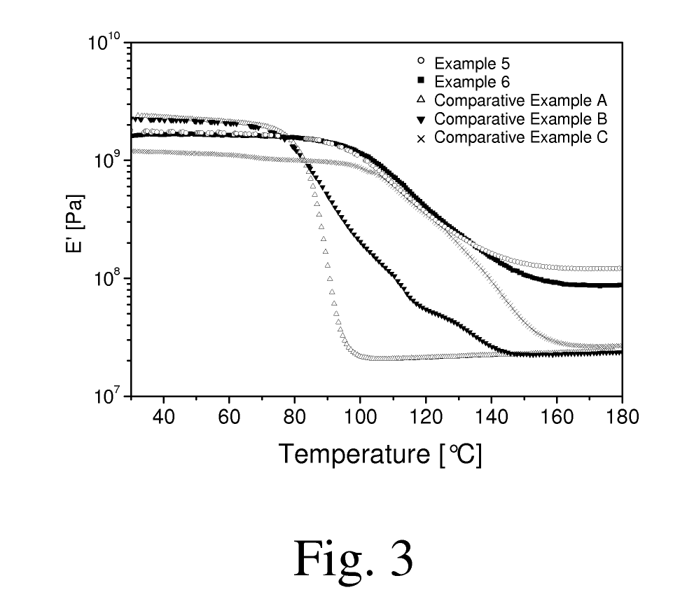

FIG. 3 shows an improvement of thermo-mechanical properties of organic-inorganic networks with different structure of inorganic clusters due to different time of sol-gel process (Examples 5 and 6) in comparison with epoxy network materials with low-condensed inorganic structures due to insufficient reaction time of hydrolysis-condensation (Comparative Example B and C) and without inorganic clusters (Comparative Example A). The composition of the present invention shows a higher mechanical transition temperature Ta and/or a higher rubbery modulus than comparative compositions.

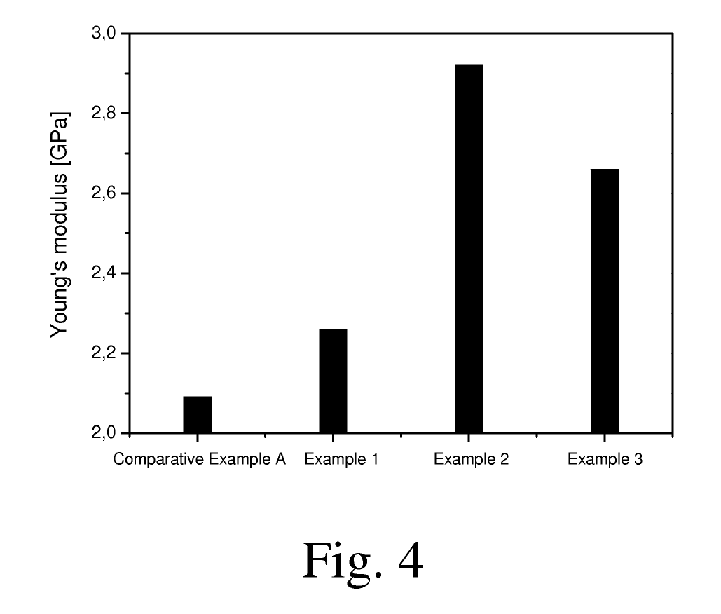

FIG. 4 shows an improvement of mechanical properties of organic-inorganic networks with different amount of SiO₂ (Examples 1, 2, and 3) in comparison with epoxy matrix without inorganic clusters (Comparative Example A). The compositions of the present invention show a higher Young's modulus than the comparative compositions.

A comparison between Comparative Example A (no silica) and Examples 2 and 3 shows that it is possible to obtain an improved balance of thermo-mechanical properties by adding a reactive inorganic cluster of the present invention to a curable composition. Example 2 (5.2% silica) leads to improved toughness (K_{Ic}) and stiffer material (E and E′ r), while maintaining similar transition temperature (Tα). A higher concentration of silica as shown in Example 3 (10.2%) leads to similar toughness than Comparative Example A while the transition temperature and the stiffness of the material are significantly increased.

A comparison between Examples 1, 2, 3, 7 and Comparative Example A shows that the higher the concentration of reactive inorganic clusters in the formulation, the better the thermo-mechanical properties (higher Tα and higher E′ r). The compositions containing reactive inorganic clusters show better thermal stability as demonstrated by the thermo-oxidative test results. Td increased with the concentration of reactive inorganic clusters when compared with Comparative Example A. The discoloration was reduced when compared to the Comparative Example A, and the thermo-mechanical properties were further improved (higher E′ r and higher Tα). Comparative Example A shows a minor increase in Tα and a significant drop in E′ r, which was explained by the partial decomposition of the network. The presence of reactive inorganic clusters prevents this decomposition and further increases the cross-linking density during thermal aging.

Examples 4, 5, and 6 show that it is possible to obtain materials with much higher transition temperature and stiffness than the Comparative Example A. The molecular chain dynamics can be tailored by varying the composition of the reactive inorganic clusters and the processing parameters.

Bulk specimens cannot be prepared with Comparative Examples B and C because of the formation of high amounts of volatile by-products during the final polymerization, generating bubbles. On thin films, Comparative Example B shows lower transition temperature and stiffness than corresponding Example 3 of the present invention. Comparative Example C shows higher transition temperature but lower stiffness.

TABLE II
Thermo-Mechanical Properties of Epoxy Networks

| | Examples | | | | | | | Comparative Examples | | |
|---|---|---|---|---|---|---|---|---|---|---|
| | 1 | 2 | 3 | 4 | 5 | 6 | 7 | A | B | C |
| Rubbery modulus E′r | 23 | 31 | 71 | 57 | 112 | 89 | 104 | 24 | 21 | 28 |
| determined by | | | | | | | | | | |
| DMTA [MPa] | | | | | | | | | | |
| Mechanical transition | 94 | 95 | 109 | 108 | 114 | 124 | 163 | 92 | 93 | 143 |
| temperature Tα | | | | | | | | | | |
| determined by | | | | | | | | | | |
| DMTA [° C.] | | | | | | | | | | |
| Young modulus E | 2.26 | 2.92 | 2.66 | n.m. | n.m. | n.m. | n.m. | 2.09 | n.m. | n.m. |
| determined by | | | | | | | | | | |
| tensile test [GPa] | | | | | | | | | | |
| K_{Ic} [MPa · m^{0.5}] | n.m. | 0.96 | 0.57 | n.m. | n.m. | n.m. | n.m. | 0.71 | n.m. | n.m. |
| Td [° C.] | 368 | 368 | 372 | n.m. | n.m. | n.m. | 381 | 354 | n.m. | n.m. |
| Transparency [visual] | clear, | clear, | clear, | n.m. | n.m. | n.m. | clear, | clear, | n.m. | n.m. |
| | trans- | trans- | trans- | | | | trans- | trans- | | |
| | parent | parent | parent | | | | parent | parent | | |
| Transmittance at | 71 | 67 | 68 | n.m. | n.m. | n.m. | 70 | 70 | n.m. | n.m. |
| 520 nm [%] | | | | | | | | | | |
| Rubbery modulus E′r | n.m. | 31 | 120 | n.m. | n.m. | n.m. | n.m. | 14 | n.m. | n.m. |
| determined by DMTA | | | | | | | | | | |
| after | | | | | | | | | | |
| 250 h at 150° C. [MPa] | | | | | | | | | | |
| Mechanical transition | n.m. | 129 | 153 | n.m. | n.m. | n.m. | n.m. | 97 | n.m. | n.m. |
| temperature Tα | | | | | | | | | | |
| determined by DMTA | | | | | | | | | | |
| after | | | | | | | | | | |
| 250 h at 150° C. [° C.] | | | | | | | | | | |
| Transparency after 250 h | brown | light | light | n.m. | n.m. | n.m. | light | black | n.m. | n.m. |
| at 150° C. [visual | | brown | brown | | | | brown | | | |
| Transmittance at 520 nm | 2 | 38 | 29 | n.m. | n.m. | n.m. | 24 | 0 | n.m. | n.m. |
| after 250 h at 150° C. [%] | | | | | | | | | | |

Notes for Table II:
n.m. = not measured

While the present disclosure includes a limited number of embodiments, those skilled in the art, having benefit of this disclosure, will appreciate that other embodiments may be devised which do not depart from the scope of the present invention. Accordingly, the scope of the present invention should be limited only by the attached claims.

1. A reactive thermosettable resin composition comprising (a) at least one thermosetting resin; (b) at least one curing agent; and (c) optionally, at least one catalyst; wherein the curing agent (b) comprises at least one or more reactive inorganic clusters formed by a reaction of an alkoxy derivative of an inorganic material and water vapor such that an alcohol byproduct is simultaneously evaporated; and wherein the clusters are storage-stable inorganic clusters with reactive functional groups.

2. The composition of claim 1, whereas the reactive functional groups are amino groups.

3. A cured product prepared by curing the composition of claim 1; wherein the cured product has a balance of thermo-mechanical properties.

4. The product of claim 3 having a rubbery modulus E′ r determined by DMTA of from about 20 MPa to about 2000 MPa; having a mechanical transition temperature Tα determined by DMTA of from about 60° C. to about 240° C.; having a Young's modulus E determined by tensile test of from about 2 GPa to about 10 GPa; having a K_{Ic} of from about 0.5 MPa·m^{0.5} to about 3 MPa·m^{0.5}; having a Td of from about 300° C. to about 450° C.; having a transmittance at 520 nm of from about 60% to about 95%; or a combination thereof.

5. A process for preparing a reactive thermosettable resin composition comprising admixing (a) at least one thermosetting resin; (b) at least one curing agent; and (c) optionally, at least one catalyst; wherein the curing agent (b) comprises at least one or more reactive inorganic clusters formed by a reaction of an alkoxy derivative of an inorganic material and water vapor such that an alcohol byproduct is simultaneously evaporated; and wherein the clusters are storage-stable inorganic clusters with reactive functional groups.

6. The process of claim 5, wherein the curing agent (b) comprises a combination of the reactive inorganic clusters with at least one conventional thermosetting resin curing agent.

7. The process of claim 5, wherein the functional groups are amino groups and the inorganic reactive clusters are used as a curing agent for an epoxy resin.

8. The process of claim 5, wherein the distribution of molecular chain dynamics is controlled through tailoring of organic-inorganic network.

9. An organic-inorganic hybrid material comprising an inorganic structure incorporated into a thermosetting resin matrix, wherein the inorganic structure is formed by a reaction of an alkoxy derivative of an inorganic material and water vapor such that an alcohol byproduct is simultaneously evaporated.

10. The organic-inorganic hybrid material product of claim 9, wherein the thermo-mechanical behavior of the organic-inorganic network during thermal aging is improved.

11. The organic-inorganic hybrid material product of claim 9, having an enhanced balance of thermo-mechanical properties (transition temperature, modulus, and toughness) and wherein the organic-inorganic network in the glassy state or in the rubbery region is enhanced.

12. A thin film or coating; or a bulk/thick product for film, coatings, castings, moldings, infusion, encapsulation, or composites, comprising the organic-inorganic hybrid material product of claim 9.

13.-15. (canceled)
